(19) United States
(12) Patent Application Publication
(10) Pub. No.: US 2014/0113177 A1
(43) Pub. Date: Apr. 24, 2014

(54) LEAD-ACID BATTERY DESIGN HAVING VERSATILE FORM FACTOR

(71) Applicant: Energy Power Systems, LLC, Troy, MI (US)

(72) Inventors: Subhash DHAR, Bloomfield Hills, MI (US); William KOETTING, Davisburg, MI (US); Michael NIELSON, Royal Oak, MI (US); Kwok TOM, Madison Heights, MI (US); Josh PAYNE, Royal Oak, MI (US)

(73) Assignee: Energy Power Systems, LLC, Troy, MI (US)

(21) Appl. No.: 14/145,692

(22) Filed: Dec. 31, 2013

Related U.S. Application Data
(63) Continuation-in-part of application No. 13/766,991, filed on Feb. 14, 2013.
Application No. 13/766,991 is a continuation of application No. PCT/US13/21287, filed on Jan. 11, 2013.
Application No. PCT/US13/21287 is a continuation of application No. 13/626,426, filed on Sep. 25, 2012.
Application No. 13/626,426 is a continuation-in-part of application No. 13/350,505, filed on Jan. 13, 2012.
Application No. 13/350,505 is a continuation-in-part of application No. 13/350,686, filed on Jan. 13, 2012.

(51) Int. Cl. H01M 10/04

(52) U.S. Cl. CPC H01M 10/0445
USPC 429/151

(57) ABSTRACT

A lead-acid battery is disclosed, wherein the battery comprises battery modules connected in series, a sealed container, a positive terminal, and a negative terminal. A battery module, in turn, comprises one or more cell assemblies electrically connected in parallel. Next in the hierarchical design, each cell assembly comprises a plurality of electrochemical cells connected in series. Finally, each electrochemical cell comprises a cathode and an anode ionically connected via a separator. In some embodiments, the plurality of modules are disposed within a common cavity in fluid communication via a common fluid. In some embodiments, each battery module has an electric potential of approximately 12 V. In some embodiments, the battery comprises four battery modules and provides a minimum electric potential of approximately 48V.

### RELATED APPLICATIONS

This application is a continuation-in-part of application Ser. No. 13/766,991, filed on Feb. 14, 2013, entitled “Lead-acid battery design having versatile form factor,” which claims priority to PCT International Application No. PCT/US2013/021287, filed on Jan. 11, 2013, and is a continuation-in-part of application Ser. No. 13/626,426, filed on Sep. 25, 2012, entitled “Lead-acid battery design having versatile form factor,” which is a continuation-in-part of application Ser. No. 13/350,686, filed Jan. 13, 2012, also entitled “Lead-acid battery design having versatile form factor,” which incorporates the entire disclosure of the concurrently filed U.S. application Ser. No. 13/350,505 entitled, “Improved Substrate for Electrode of Electrochemical Cell.” This application incorporates, by reference, the entire disclosure of each of the above-listed applications.

### TECHNICAL FIELD

Embodiments of the present disclosure relate generally to electrochemical cells. More particularly, embodiments of the present disclosure relate to a design of a lead-acid electrochemical cell.

### BACKGROUND

Lead-acid electrochemical cells have been commercially successful as power cells for over one hundred years. For example, lead-acid batteries are widely used for starting, lighting, and ignition (SLI) applications in the automotive industry.

As an alternative to lead-acid batteries, nickel-metal hydride (“Ni-MH”) and lithium-ion (“Li-ion”) batteries have been used for hybrid and electric vehicle applications. Despite their higher cost, Ni-MH and Li-ion electro-chemistries have been favored over lead-acid electrochemistry for hybrid and electric vehicle applications due to their higher specific energy and energy density compared to lead-acid batteries.

Lead-acid batteries have many advantages. They are low-cost and are capable of being manufactured in any part of the world. Accordingly, production of lead-acid batteries can be readily scaled-up. Lead-acid batteries are available in large quantities in a variety of sizes and designs. In addition, they deliver good high-rate performance and moderately good low- and high-temperature performance. Lead-acid batteries are electrically efficient, with a turnaround efficiency of 75 to 80%, provide good “float” service (where the charge is maintained near the full-charge level by trickle-charging), and exhibit good charge retention. Although lead is toxic, lead-acid battery components are easily recycled. An extremely high percentage of lead-acid battery components (in excess of 95%) are typically recycled. Overall, lead-acid battery technology is low-cost, reliable, and relatively safe.

Existing lead-acid batteries, however, suffer from certain disadvantages. Certain applications, such as complete or partial electrification of vehicles and back-up power applications require higher specific energy than traditional SLI lead-acid batteries deliver. Existing lead-acid batteries have a low specific energy due to the weight of the components.

Moreover, existing lead-acid batteries offer relatively low cycle life, particularly in deep-discharge applications. Due to the weight of the lead components and other structural components needed to reinforce the plates, lead-acid batteries typically have limited energy density. If lead-acid batteries are stored for prolonged periods in a discharged condition, sulfation of the electrodes can occur, damaging the battery and impairing its performance. In addition, hydrogen can be evolved in some designs.

Automobile manufacturers have encountered substantial consumer resistance in launching fleets of electric vehicles and hybrid vehicles. One reason for the resistance is the increased cost of these vehicles relative to conventional automobiles powered by an internal combustion engine (“ICE”). Environmental and energy independence concerns have exerted greater pressures on manufacturers to offer cost-effective alternatives to internal combustion engine-powered vehicles. Although hybrids and electric vehicles can meet that demand, they typically rely on subsidies to defray the higher cost of the energy storage systems.

Table 2 below compares the application of various battery electro-chemistries and the internal combustion engine (ICE) and their current roles in certain automotive applications. As used in Table 2, “SLI” means starting, lighting, ignition; “HEV” means hybrid electric vehicle; “PHEV” means plug-in hybrid electric vehicle; “EREV” means extended range electric vehicle; and “EV” means electric vehicle.

TABLE 2

| | | | Power | | Mild | | | | |
|---|---|---|---|---|---|---|---|---|---|
| | SLI | Start/Stop | Assist | Regeneration | Hybrid | HEV | PHEV | EREV | EV |
| Pb- | ✓ | | | | | | | | |
| Acid | | | | | | | | | |
| Ni- | | | ✓ | ✓ | ✓ | ✓ | | | |
| MH | | | | | | | | | |
| Li- | | | ✓ | ✓ | ✓ | ✓ | ✓ | ✓ | ✓ |
| ion | | | | | | | | | |
| ICE | ✓ | ✓ | ✓ | ✓ | ✓ | ✓ | ✓ | ✓ | |

As shown in Table 2, there remains a need for specific applications in which partial electrification of the vehicle may provide environmental and energy efficiency advantages, without the same level of added costs associated with hybrid and electric vehicles using Ni-MH and Li-ion batteries. Even more specifically, there is a need for a low cost, energy efficient battery in the area of start/stop automotive applications.

Specific points in the duty cycle of an internal combustion engine entail far greater inefficiency than others. Internal combustion engines operate efficiently only over a relatively narrow range of crankshaft speeds. For example, when the vehicle is idling at a stop, fuel is being consumed with no useful work being done. Idle vehicle running time, stop/start events, power steering, air conditioning, or other power electronics component operation entail substantial inefficiencies in terms of fuel economy, as do rapid acceleration events. In addition, environmental pollution from a vehicle at these “start-stop” conditions is far worse than from a running vehicle that is moving.

The partial electrification of the vehicle in relation to these more extreme operating conditions has been termed a “micro” or “mild” hybrid application, including start/stop electrification. Micro- and mild-hybrid technologies are unable to displace as much of the power delivered by the internal combustion engine as a full hybrid or electric vehicle. Nonetheless, they may be able to substantially increase fuel efficiency in a cost-effective manner without the substantial capital expenditure associated with full hybrid or full electric vehicle applications.

Conventional lead-acid batteries have not yet been able to fulfill this role. Conventional lead-acid batteries have been designed and optimized for the specific application of SLI operation. The needs of a mild hybrid application are different. A new process, design, and production process need to be developed and optimized for the mild hybrid application.

One need for a mild hybrid application is low-weight battery. Conventional lead-acid batteries are relatively heavy. This causes the battery to have a low specific energy due to the substantial weight of the lead components and other structural components that are necessary to provide rigidity to the plates. SLI lead-acid batteries typically have thinner plates, providing increased surface area needed to produce the power necessary to start the engine. But the grid thickness is limited to a minimum useful thickness because of the casting process and the mechanics of the grid hang. The minimum grid thickness is also determined on the positive electrode by corrosion processes. Positive plates are rarely less than 0.08″ (main outside framing wires) and 0.05″ on the face wires because of the difficulties of casting at production rates and, more importantly, concern over poor cycle-life issues. These parameters limit power. Lead-acid batteries designed for deeper discharge applications (such as motive power for forklifts) typically have heavier plates to enable them to withstand the deeper depth of discharge in these applications.

Another need for a mild hybrid application is that rechargeable batteries should be able to be charged and discharged with less than 0.001% energy loss at each cycle. This is a function of the internal resistance of the design and the overvoltage necessary to overcome it. The reaction should be energy-efficient and should involve minimal physical changes to the battery that might limit cycle life. Side chemical reactions that may deteriorate the cell components, cause loss of life, create gaseous byproducts, or loss of energy should be minimal or absent. In addition, a rechargeable battery should desirably have high specific energy, low resistance, and good performance over a wide range of temperatures and be able to mitigate the structural stresses caused by lattice expansion. When the design is optimized for minimum resistance, the charge and discharge efficiency may dramatically improve.

Lead-acid batteries have many of these characteristics. The charge-discharge process is essentially highly reversible. The lead-acid system has been extensively studied and the secondary chemical reactions have been identified. And their detrimental effects have been mitigated using catalyst materials or engineering approaches. Although its energy density and specific energy are relatively low, the lead-acid battery performs reliably over a wide range of temperatures, with good performance and good cycle life. A primary advantage of lead-acid batteries remains their low-cost.

A number of trade-offs must be considered in optimizing lead-acid batteries for various standby power and transportation uses. High-power density requires that the initial resistance of the battery be minimal. High-power and energy densities also require the plates and separators to be highly porous. High cycle life, in contrast, requires optimized separators, shallow depth of discharge, and the presence of alloying elements in the substrate grids to reduce corrosion. Low-cost, in further contrast, requires both minimum fixed and variable costs, high-speed automated processing, and that no premium materials be used for the grid, paste, separator, or other cell and battery components.

Thus, there remains a need for low-cost, reliable, and relatively safe electrochemical cells for various applications that require high specific energy, including certain automotive and back-up power applications. Lead-acid battery systems may provide a reliable replacement for Li-ion or Ni-MH batteries in various acceleration applications, without the substantial safety concerns associated with Li-ion electrochemistry and the increased cost associated with both Li-ion and Ni-MH batteries. There remains, however, a need for further improvements in the design and composition of lead-acid electrochemical cells to meet the specialized needs of the automotive and standby power markets. Specifically, there remains a need for a reliable replacement for lithium-ion electrochemical cells in certain applications that do not entail the same safety concerns raised by Li-ion electrochemical cells. Similarly, there remains a need for a reliable replacement for Ni-MH and Li-ion electrochemical cells with the added benefits of low-cost and reliability of lead-acid electrochemical cells. In addition, there remains a need for substantial improvement in battery production capacity to meet the growing needs of the automotive and standby power segments.

### SUMMARY

In various embodiments, a battery is provided, wherein the battery comprises a plurality of battery modules connected in series, wherein each battery module comprises one or more cell assemblies electrically connected in parallel, each cell assembly comprises a plurality of electrochemical cells connected in series, and each electrochemical cell comprises a cathode and an anode ionically connected via a separator; a container in which the battery modules are sealed from outside the battery; and a positive terminal and a negative terminal for connecting the outside to the electrically connected battery modules.

In some embodiments, the plurality of modules are disposed within a common cavity in fluid communication via a common fluid. In some embodiments, a common fluid comprises a gas. In some embodiments, each battery module has an electric potential of approximately 12 V. In some embodiments, the battery comprises four battery modules and provides a minimum electric potential of approximately 48V. In some embodiments, each cell assembly comprises a plurality of electrochemical cells connected in series via wire grids. In some embodiments, the battery modules are stacked on top of one another. In some embodiments, one pair of the battery modules is connected via a power bus. In some embodiments, the power bus is attached to the pair of batteries by ultrasonic welding. In some embodiments, the power bus has a serpentine configuration.

In some embodiments, the battery further comprises an isolator plate placed between two adjacent battery modules. In some embodiments, the isolator plate comprises rib supports on both sides. In some embodiments, the isolator plate comprises a chemical reservoir.

In some embodiments, the battery comprises an approximately 10-20 Ahr battery. In some embodiments, the battery comprises an approximately 15 Ahr battery.

Additional objects and advantages of the disclosure will be set forth in part in the description which follows, and in part will be apparent from the description, or may be learned by practice of the disclosure. The objects and advantages of the disclosure will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one embodiments of the disclosure and together with the description, serve to explain the principles of the disclosure.

### BRIEF DESCRIPTION OF THE DRAWINGS

FIG. 1A is a schematic isometric view of a bipolar electrode plate according to an embodiment of the present disclosure.

FIG. 1B is a schematic isometric view of an electrochemical cell according to an embodiment of the present disclosure.

FIG. 2 is an exploded isometric view of a cell assembly according to an embodiment of the present disclosure.

FIG. 3 is a schematic isometric view of a portion of a battery module with a plurality of cell assemblies in a stacked configuration according to an embodiment of the present disclosure.

FIG. 4A is an isometric front view of the exterior of a battery constructed from a plurality of battery modules as depicted in FIG. 3 according to an embodiment of the present disclosure.

FIG. 4B is an isometric back view of the exterior of a battery constructed from a plurality of battery modules as depicted in FIG. 3 according to an embodiment of the present disclosure.

FIG. 5 is an exploded isometric view of a battery according to an embodiment of the present disclosure.

FIG. 6A is a side view of the interior of a 48 volt battery according to an embodiment of the present disclosure.

FIG. 6B is an isometric view of the terminal side of an embodiment of the present disclosure.

FIG. 6C is a view of the back side of an embodiment of the present disclosure.

FIG. 6D is an isometric view of a cutaway of an embodiment of the present disclosure.

FIG. 7A is a side view of the interior of a 48 volt battery according to an embodiment of the present disclosure.

FIG. 7B is an isometric view of the terminal side of an embodiment of the present disclosure.

FIG. 7C is a view of the back side of an embodiment of the present disclosure.

FIG. 7D is an isometric view of a cutaway of an embodiment of the present disclosure.

FIG. 8 is a diagram of an isolator used in a battery according to an embodiment of the present disclosure.

FIG. 9 is a diagram of the parallel and serial connectors in a battery of an embodiment of the present disclosure.

FIG. 10 is a diagram of the current paths in a battery of an embodiment of the present disclosure.

### DETAILED DESCRIPTION

The following detailed description refers to the accompanying drawings. Wherever possible, the same reference numbers may be used in the drawings and the following description to refer to the same or similar parts. Also, similarly-named elements may perform similar functions and may be similarly designed. Numerous details are set forth to provide an understanding of the embodiments described herein. In some cases, the embodiments may be practiced without these details. In other instances, well-known techniques and/or components may not be described in detail to avoid obscuring described embodiments. While several exemplary embodiments and features are described herein, modifications, adaptations, and other implementations are possible, without departing from the spirit and scope of the invention. Accordingly, the following detailed description does not limit the invention. Instead, the proper scope of the invention is defined by the appended claims.

Embodiments of the present disclosure generally relate to a design of a lead-acid electrochemical cell. Lead-acid electrochemical cells typically are in the form of stacked plates with separators between the plates. Accordingly, embodiments of the present disclosure relate to improved stacking of electrode plates in a variety of form factors. The improved stacking and variety of form factors of the lead-acid electrochemical cell design may enable lead-acid electrochemical cells to be used as part of lead-acid batteries, which, in turn, may be used in automobiles to aid in increasing fuel efficiency.

More specifically, embodiments of the present disclosure may include improvements to the design of a lead-acid electrochemical cell which may include improvements to the orientation of electrode plates as well as improvements for mitigating shunt currents. The improvements may result in a lead-acid electrochemical cell that may have a higher voltage while maintaining a lower weight and size. Alternatively, the present disclosure enables production of cells having higher capacity at the same relative voltage.

Embodiments of the present disclosure may allow for the use of lead-acid batteries in micro and mild-hybrid applications of vehicles, either alone or in combination with Ni-MH or Li-ion batteries. Some embodiments use other electrochemical batteries having a specific energy above 50 Wh/kg and a specific power above 500 W/kg. It should be emphasized, however, that embodiments of the present disclosure are not limited to transportation and automotive applications. Embodiments of the present disclosure may be of use in any area known to those skilled in the art where use of lead-acid batteries is desired, such as stationary power uses and energy storage systems for back-up power situations. Further, the present inventors intend that the elements or components of the various embodiments disclosed herein may be used together with other elements or components of other embodiments.

Some embodiments include a hierarchy of elements that are included in a battery. In particular, bipolar plates are combined to form sets of individual cell in a cell assembly; cell assemblies are combined to form battery modules; and battery modules are combined to form batteries. In some embodiments, a cell assembly includes two or more cells that are connected in series; a module includes two or more cell assemblies connected in parallel; and the battery includes two or more modules that are connected in series.

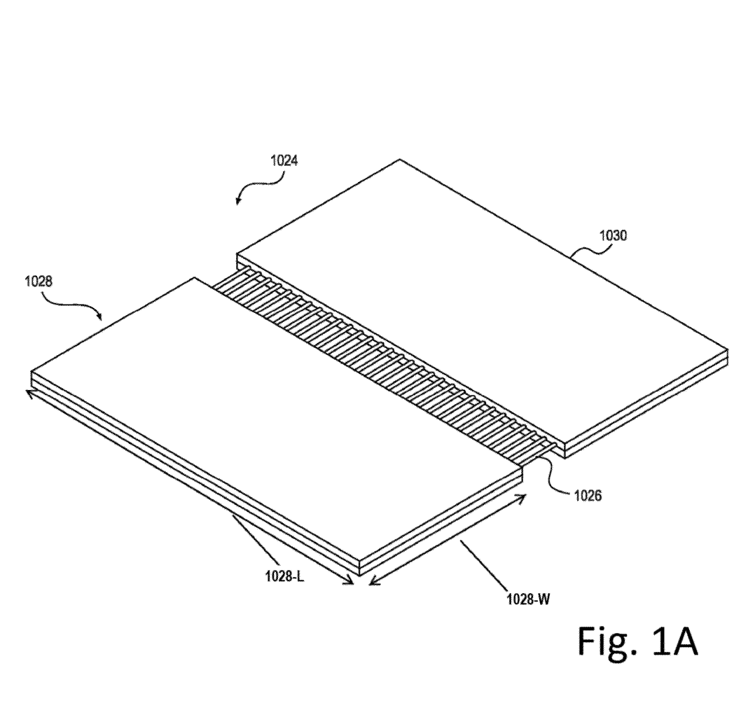

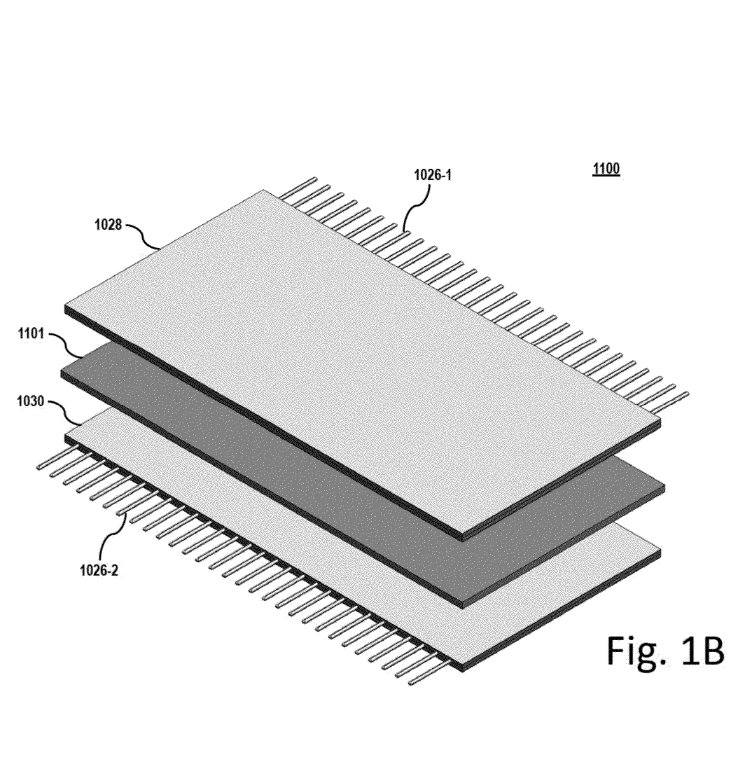

An electrochemical cell may be configured in an elongated rectangular shape. FIG. 1A illustrates a bipolar electrode plate 1024 of a lead-acid electrochemical cell according to an embodiment of the present disclosure. The electrode plate 1024 may include a first, positive half-plate portion 1028 and a second, negative half-plate portion 1030, with electrode connectors 1026 in between. In various embodiments, each electrode plate portion 1028 or 1030 has a width 1028-W in the direction of electron flow and a length 1028-L perpendicular to that direction. In various embodiments, each electrode plate has an aspect ratio, that is, a ratio of its length to its width (the length of 1028-L over the length of 1028-W) that is greater than one. In some embodiments, the ratio of length to width is about 1.5. In some other embodiments this ratio is about 2.0. Such aspect ratios increase the efficiency of the battery cells as, for the same total surface of the electrode plates, the electron requires a shorter path to travel.

FIG. 1B illustrates an electrochemical cell 1100 according to an embodiment of the disclosure. Cell 1100 comprises a positive half-plate portion 1028 placed over a negative half-plate portion 1030 with a separator 1101 sandwiched between the half-plates. The electrode connectors 1026-1 associated with the positive half-plate portion 1028 and the electrode connectors 1026-2 associated with the negative half-plate portion 1030, which are on opposite sides of the cell, may connect to half-plate portions of electrode plates of other cells.

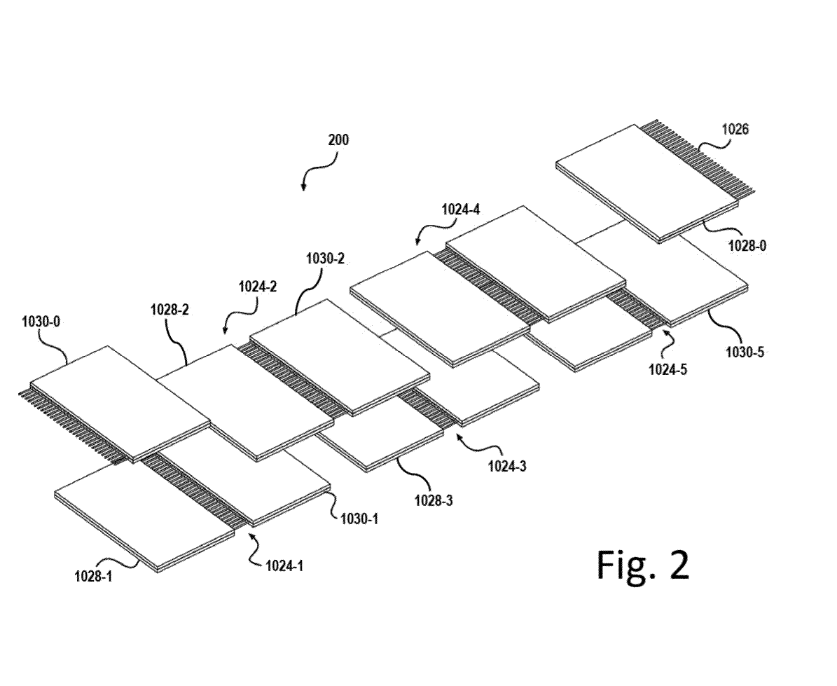

In some embodiments, electrode plates are assembled together in bi-layers to form an assembly of cells. In an embodiment of a cell assembly, as shown in FIG. 2, electrode plates may be disposed in a capacity-building configuration. As shown in FIG. 2, a cell assembly 200 has been formed by aligning a desired number of bipolar electrode plates 1024. Cell assembly 200 combines two layers of bipolar plates or half-plates. In particular, five plates 1024 -1 to 1024-5 and two half-plates 1028-0 and 1030-0 have been aligned to form cell assembly 200 with six cells. A cell may be formed by, for example, aligning a positive half-plate (e.g., half plate 1028-2) of a bipolar plate (here plate 1024-2) on top of a negative half-plate (here, half-plate 1030-1) of another bipolar plate (here plate 1024-1); or by aligning a negative half-plate (e.g., half-plate 1030-2) of a bipolar plate (here plate 1024-2) on top of a positive half-plate (here half-plate 1028-3) of another bipolar plate (here plate 1024-3); and by locating a separator between each stacked pair of positive and negative half-plates. Cell assembly 200 thus aligns five bipolar plates 1024-1 to 1024-5, in the manner seen in FIG. 2. This assembly results in an free positive half-plate 1028-1 of a bottom electrode plate 1024-1 at one end, and a free negative half-plate 1030-5 of another bottom electrode plate 1024-5 at the opposite end. To complete the circuit in cell assembly 200, individual negative and positive half-plates 1030-0 and 1028-0, respectively are placed on top of these free ends. Cell assemblies may be formed of any desired voltage. For example, cell assembly 200 of FIG. 2, combining 6 cells of about 2 Volts each, which may from a 12-Volt cell assembly.

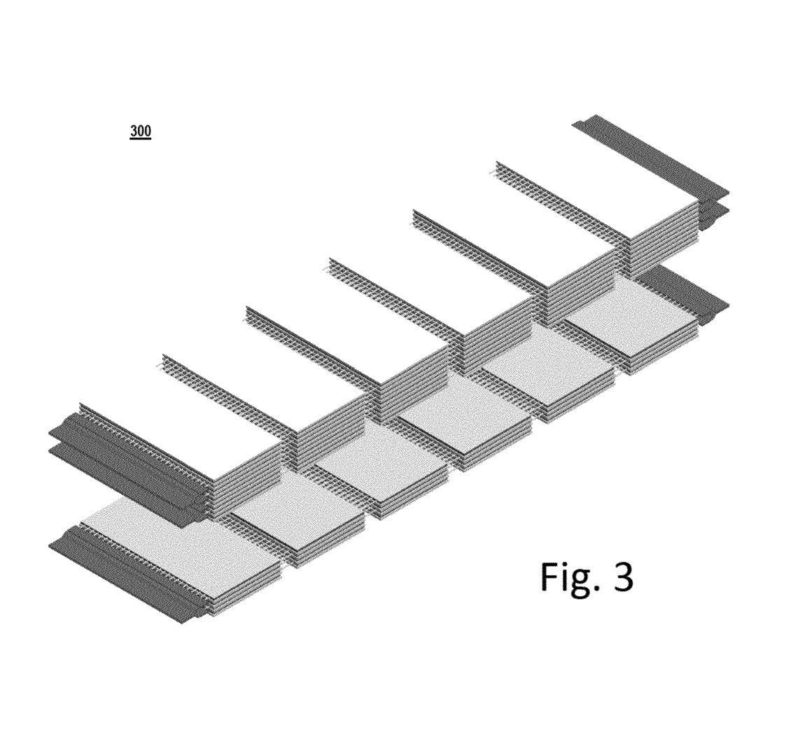

In some embodiments, cell assemblies are assembled together to form a battery module. FIG. 3 illustrates a battery module 300 according to an embodiment. Battery module 300 may include multiple stacked cell assemblies 200 of FIG. 2, connected in parallel. The battery module 300 may include tabs 50. Each tab may include a through-hole 52 and may be connected via soldering or ultrasonic welding to a positive end or a negative end of each cell assembly. FIG. 3, however, illustrates that tab 50 may be connected to two cell assemblies, as opposed to only one. In battery module 300, multiple bi-layers cell assemblies are stacked such that the positive ends of the cell assemblies are positioned on one end and negatives ends are positioned on the other end. The positive ends or negative ends are then connected either via tabs or by connection of end tabs to the positive or negative terminal of the battery module.

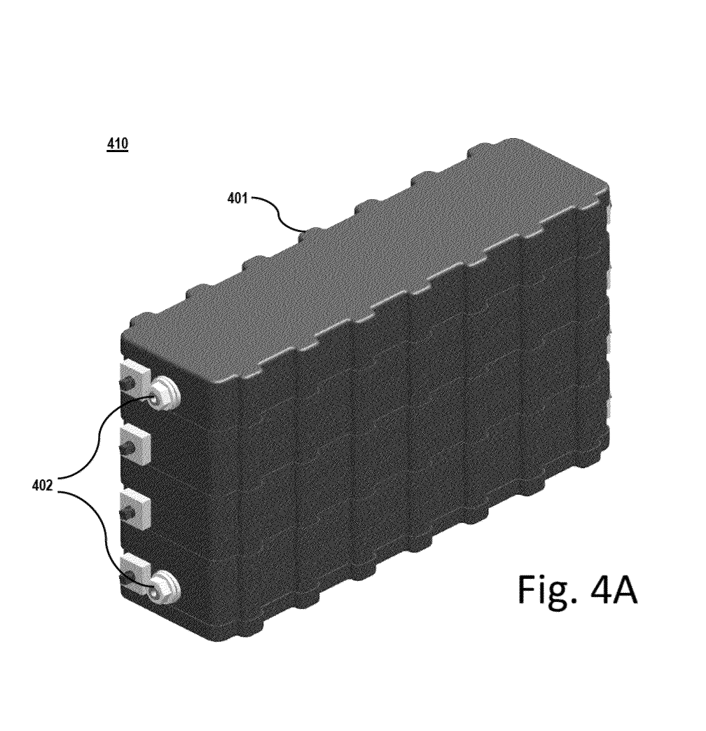

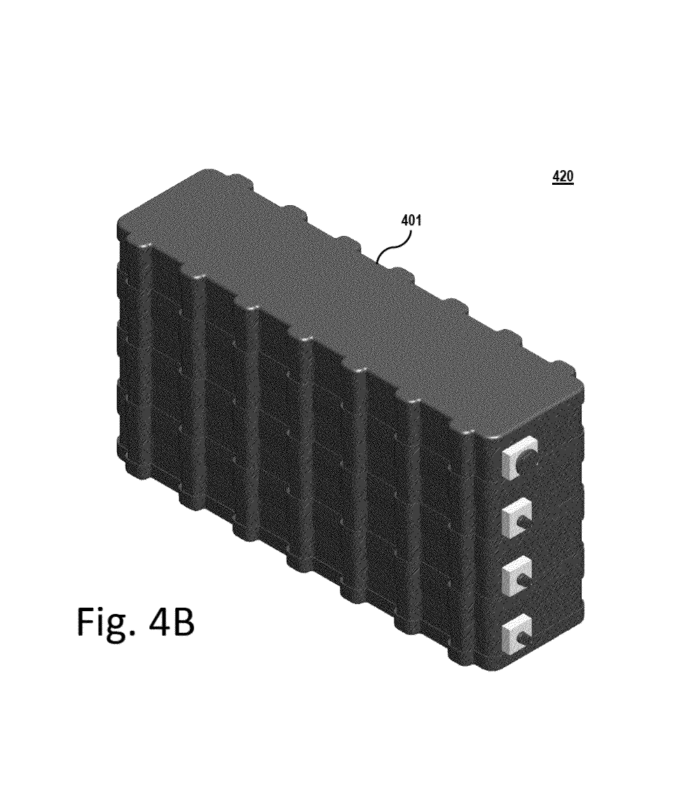

In some embodiments, battery modules are assembled together to form a battery. FIG. 4A illustrates an isometric front view 410 of the exterior of a battery 401 with positive and negative terminals 402 according to an embodiment. FIG. 4B illustrates an isometric back view 420 of the exterior of battery 401.

Compression is achieved by internal dimension of the parts as assembled. Uniform compression is achieved through structural features designed into the components for mechanical strength. Uniform compression is important to control uniform current density, low Ohmic resistance and even electrolyte distribution. Battery 401 may comprise multiple battery modules connected in series or in parallel. Battery 401 includes positive and negative terminals 402. In some embodiments, the modules are disposed within a common cavity.

In some embodiments, the modules are in fluid communication via a common fluid, such as liquid and/or gas. Fluid communication refers to a configuration, in which cells, cell assemblies, and/or modules comprising the 48V and 12V assemblies of certain embodiments are contained in the same housing. During charging, hydrogen may be evolved due to the electrolysis of water in the electrolyte. The “common fluid” here refers to both liquid electrolyte as well as these gas evolution products. By containing the “fluids” in a common housing, water and electrolyte may be conserved.

In contrast, when cells or cell assemblies are housed separately, gas evolution may increase pressure in a cell or assembly to the point where it exceeds the vent pressure, allowing evoluted gas to escape. This may deprive the electrolyte of water when these vented gas evolution products are no longer available to recombine within the housing. In this manner, the “fluid” communication between cells, assemblies, and modules helps conserve water, and therefore electrolyte, delaying, retarding, or preventing the battery from drying out due to loss of water in the electrolyte.

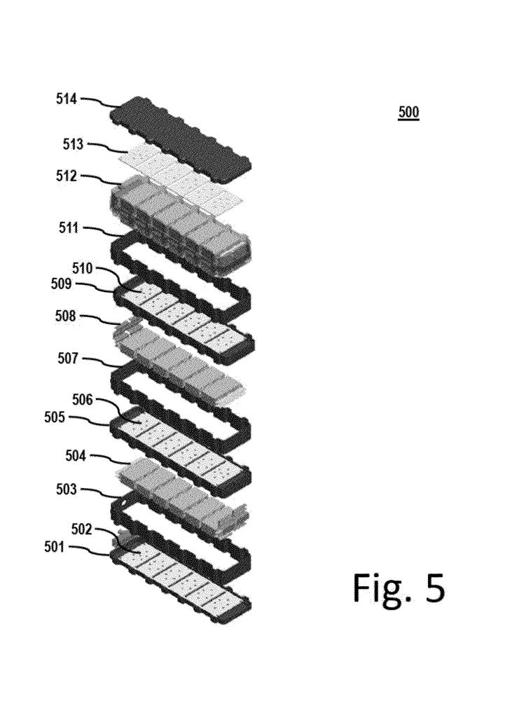

FIG. 5 is an exploded isometric view of an embodiment of a four-module, 48V battery 500. Battery 500 includes a lower lid 501, a first insert 502, a first skirt 503, a first battery module 504, a first isolator 505, a second insert 506, a second skirt 507, a second battery modules 508, a second isolator 509, a third insert 510, a third skirt 511, third and fourth battery modules show as a combined module 512, a fourth insert 513, and an upper lid 514. Each battery module includes one or more cell assemblies that are connected to each other in parallel.

First insert 502 is used as an insert for lower lid 501, second insert 506 is used as an insert for first isolator 505, third insert 510 is used as an insert for second isolator 509, and fourth insert 513 is used as an insert for upper lid 514. Inserts 502, 506, 510, and 513 add stiffness to lid 501, isolators 505 and 509, and lid 514, respectively. In some embodiments, inserts may increase the stiffness of the lids and isolators with little additional material and weight. Added stiffness may help the module resist deformation or bulging of the case. Absent this added stiffness, bulging may occur due to the normal cycling of the battery, which can result in an increase of gas pressure inside the battery and can deform the casing and cause the battery to bulge. This bulging could result in a loss of compression as well as non-uniform compression of the electrode stacks.

In some embodiments, the inserts include alignment holes formed therein to aid in proper positioning. Adhesives may be applied to the ribs of the base or the lid to secure the inserts against them. Moreover, in some embodiments, inserts may be bonded to the ribbing in the internal surfaces of the lids or isolators, forming a dual skin assembly. This dual-skin assembly resists bending loads that may be caused by stack compression and internal gas pressure.

In some embodiments, the inserts may be made of the same material as the skirts 503, 507, and 511. This material permits a high degree of flexibility in bonding the parts. In some embodiments, inserts are made from polypropylene sheet.

Inserts may be punched, cut, molded, or formed by other suitable forming techniques. Alternatively, inserts may be made from high impact polystyrene (HIPS); acrylonitrile butadiene styrene (ABS); polyvinyl chloride (PVC), any suitable composite, or other thermoplastic material that is acid-resistant, high-strength, and easily formed. Inserts may help prevent or reduce electrolyte leakage.

Inserts may prevent loss of compression of the electrodes and maintain even levels of compression across the electrode stacks. Further, the inserts may help prevent shorting by providing gaps between the electrode stacks that prevent liquid pathways from forming between adjacent electrode stacks that may otherwise may cause shorting.

In some embodiments, the inserts may include apertures formed therein. The apertures may permit excess liquid electrolyte to drain from the electrode stacks to the bottom trench formed in the base. In addition, apertures may provide pathways for the escape of gas from the electrode stacks. Inserts may also be formed to establish pads for positioning the electrode stacks within the battery.

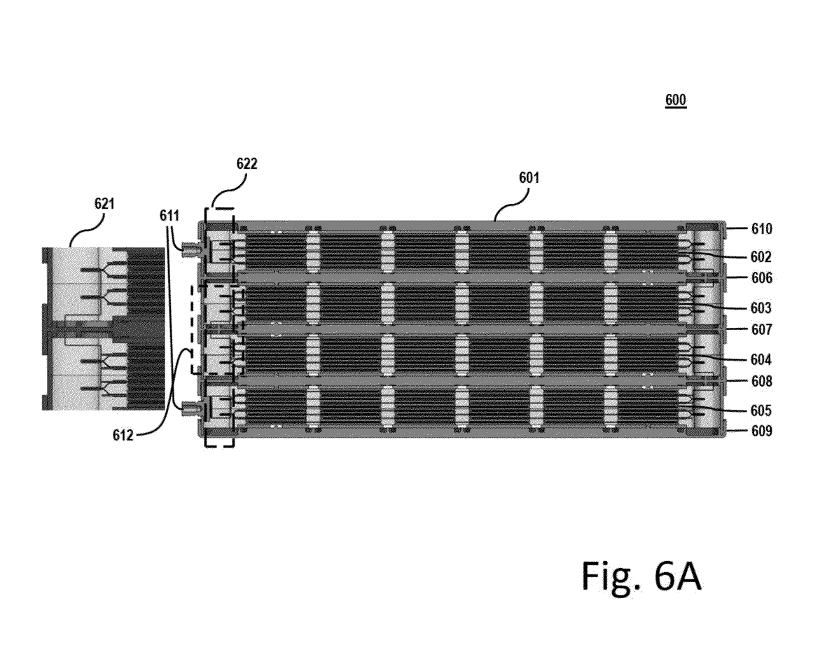

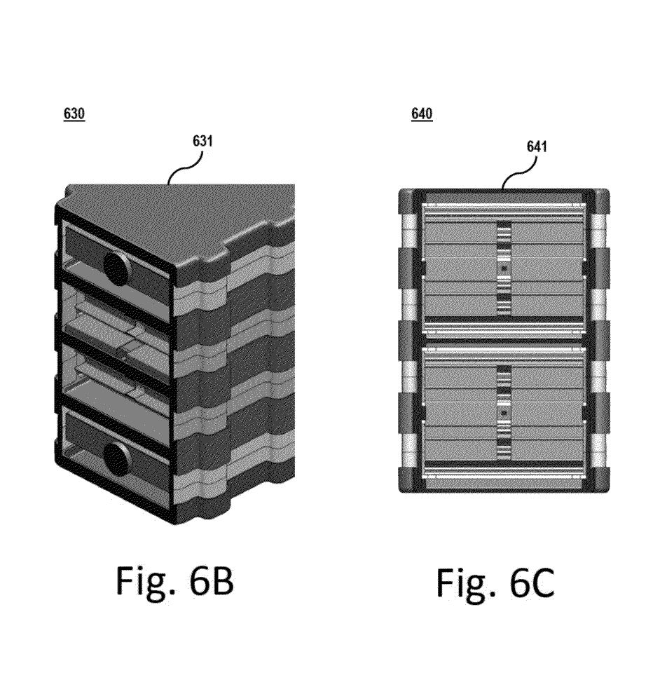

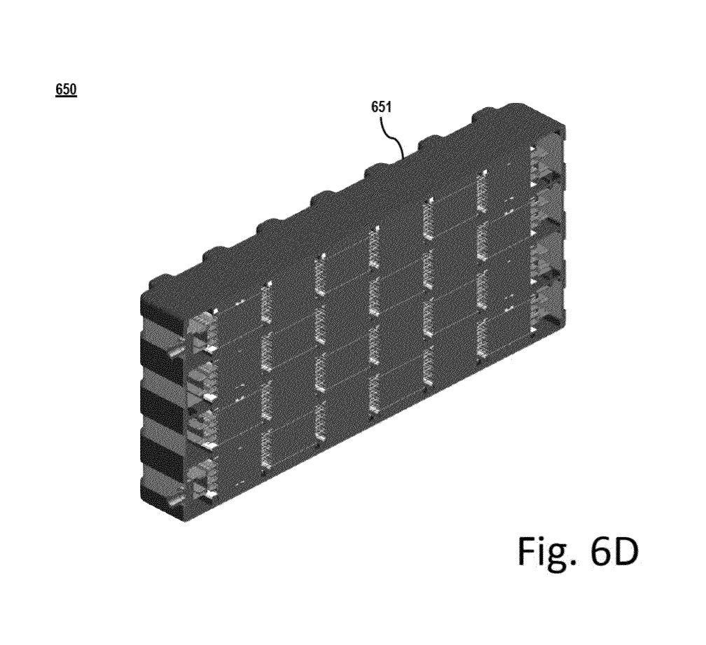

FIG. 6A shows a side view 600 of the interior of a first embodiment of a 48 V battery 601 having four battery modules. FIG. 6A also depicts an expanded view 621 of busbar portion 612 of battery 601. In this embodiment, the 48V battery has a capacity of 8.5 AHr with 20% compression

Battery 601 includes four battery modules 602, 603, 604, and 605, a busbar 622, lower and upper lids 609 and 610, and terminals 611. Busbar 622 carries current between battery modules 602-605, and may be designed to dissipate heat efficiently. Battery modules 602-605 are vertically stacked, with each adjacent pair separated by one of isolators 606, 607, and 608. The stack may be capped by lower lid 609 and upper lid 610. Battery 601 may be accessed via positive and negative terminals 611.

In FIG. 6A, busbar portion 612 is shown in expanded view 621. As seen in expanded view 621, busbar portion 612 connect two adjacent battery modules in series. Moreover, each busbar portion for one battery module connects in parallel two layers of cell assemblies to each other to form the battery module The two single layer busbar serpentine is the series connector for two adjacent battery modules.

FIG. 6B is an isometric view 630 of a terminal side 631 of the first embodiment and FIG. 6C is a view 640 of the back side 641 of the first embodiment. FIG. 6D is an isometric view 650 of a cutaway 651 of the first embodiment. Weldability is improved by the design of the terminal backside and the two single layer busbar serpentine is the series connector for two adjacent battery modules. The terminal side important features are to provide a sealed interface to the outside world.

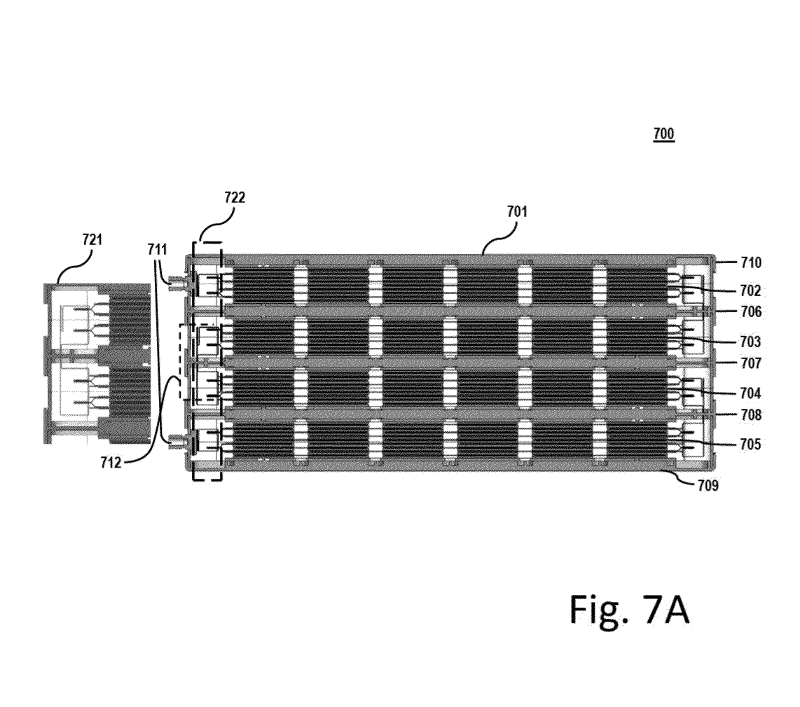

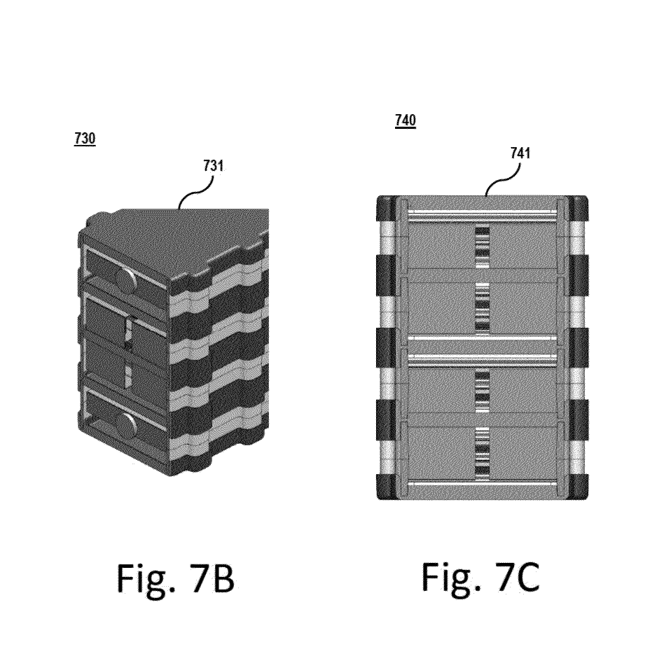

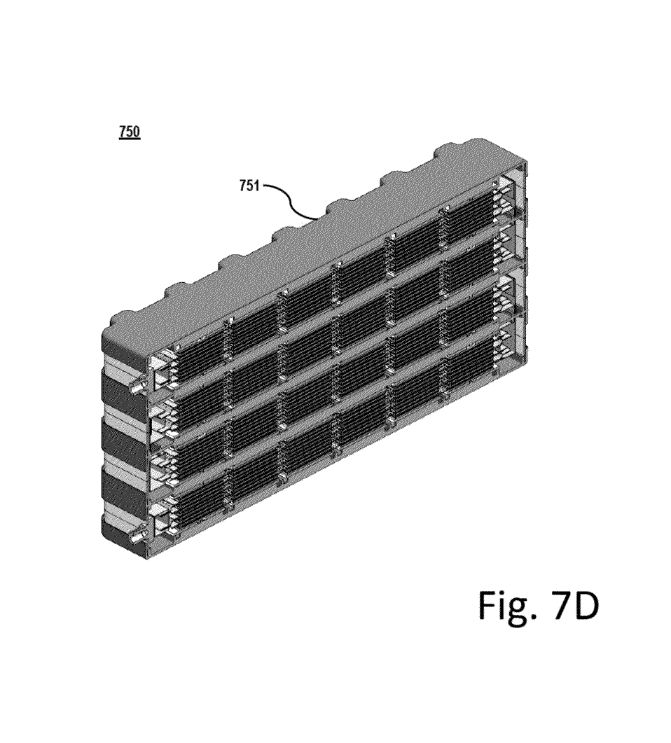

FIG. 7A shows a side view 700 of the interior of a second embodiment of a 48 V battery 701 having four battery modules. FIG. 7A also shows an expanded view 721 of a busbar portion 712 of battery 701. In this embodiment, the 48V battery has a capacity of 8.5 AHr with 20% compression Battery 701 includes four battery modules 702, 703, 704, and 705, a busbar 722, lower and upper lids 709 and 710, and terminals 711. Busbar 722 carries current between battery modules 702-705, and may be designed to dissipate heat efficiently. Battery modules 702-705 are vertically stacked, with each adjacent pair separated by one of isolators 706, 707, and 708. The stack may be capped by lower lid 709 and upper lid 710. Battery 701 is accessed by positive and negative terminals 711.

In FIG. 7A, busbar portion 712 is shown in expanded view 721. As seen in expanded view 721, busbar portion 712 connects two adjacent modules in series. Moreover, each section of the busbar for each battery module connects two layers of cell assemblies in parallel. Weldability is improved by the design of the terminal backside and the two single layer busbar serpentine is the series connector for two adjacent battery modules. The terminal side important features are to provide a sealed interface to the outside world.

FIG. 7B is an isometric view 730 of a terminal side 731 of the second embodiment, FIG. 7C shows a view 740 of the back side 741 and FIG. 7D shows an isometric view 750 of a cutaway 751 of the second embodiment. Weldability is improved by the design of the terminal backside and the two single layer busbar serpentine is the series connector for two adjacent battery modules. The terminal side important features are to provide a sealed interface to the outside world.

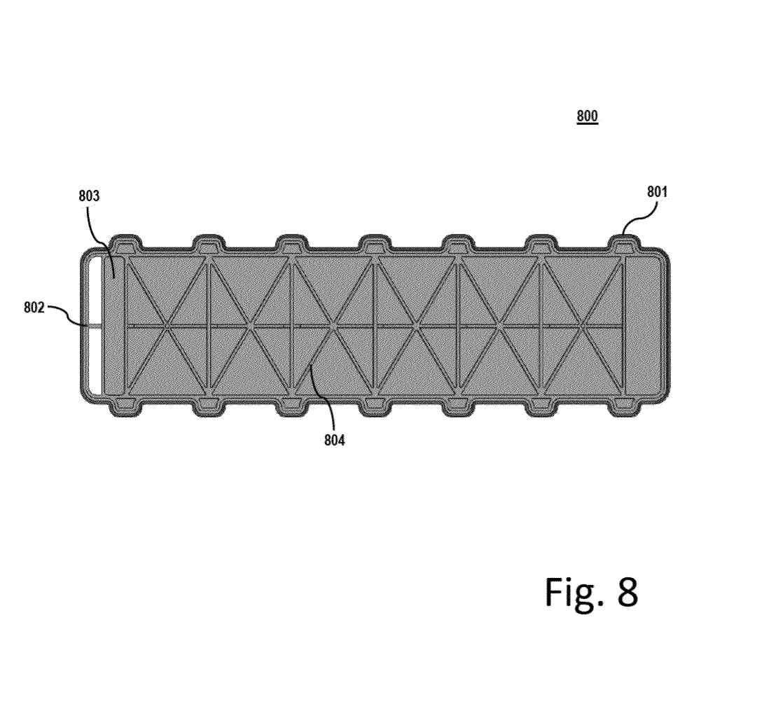

FIG. 8 is a diagram 800 of an isolator 801 used in the battery according to an embodiment. Isolator 801 includes a busbar center support 802, reservoir 803, and rib supports 804 on both sides. The isolator has the function to electrically and mechanically separate individual module layers. The rib support provides structural support to the insert (502, 506, 510 and 513) which in turn provides an even interface to the electrodes.

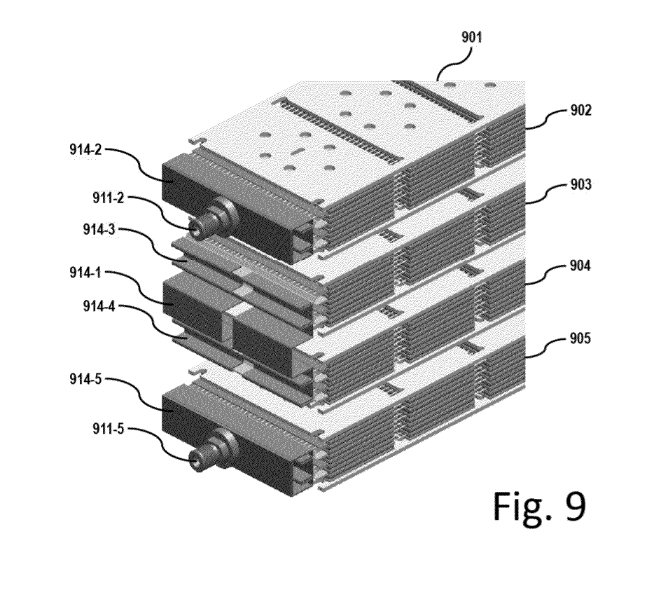

FIG. 9 shows a section of battery 901, which includes parallel and serial connectors, according to an embodiment of the present disclosure. Battery 901 includes a top battery module 902, a first intermediate battery module 903, a second intermediate battery module 904, a bottom battery module 905, positive and negative terminals 911-2 and 911-5, and busbars 914-1 to 914-5. In each battery modules 902-905, the corresponding busbar connects two cell assemblies of the battery module in parallel. That is, in battery modules 902, for example, busbar 914-2 connects in parallel two cell assemblies of module 902. Busbar 914-1, on the other hand, connects battery modules 903 and 904 in series, by connecting busbar 903 to busbar 904.

In various embodiments, different portions are named as “top” and “bottom” portions. Similarly, in various embodiments, references are made to vertical and horizontal directions. These namings are for reference only and do not necessarily signify relative locations of the portions. In particular, various embodiments may be used in different orientations, which may cause the “top” and “bottom” portions to be oriented in various relationships with each other. For example, in different orientations of an embodiment, a “top” portion may be located directly above, at an angle above, side by side, at an angle below, or directly below a “bottom” portion.

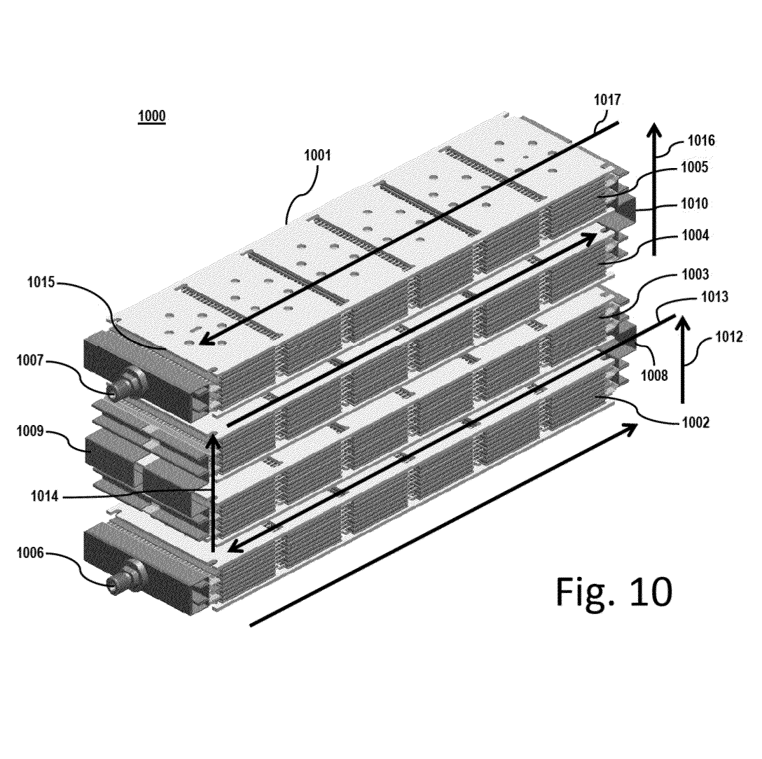

FIG. 10 shows a diagram 1000 of the current paths in a battery 1001 according to an embodiment of the present disclosure. Battery 1001 includes a bottom battery module 1002, a first intermediate battery module 1003, and second battery module 1004, a top battery module 1005, a negative terminal 1006, a positive terminal 1007, a first connector 1008, a second connector 1009, and a third connector 1010. The current path starts at negative terminal 1006 and ends at positive terminal 1007. The current path is divided into seven legs. A first leg 1011 of the current path starts at one end of bottom battery module 1002 connected to negative terminal 1006. First leg 1011 moves through bottom battery module 1002 and ends at the other end of battery module 1002. A second leg 1012 of the current path moves through first connector 1008, which is connected to the other end of bottom battery module 1002 and one end of first intermediate battery module 1003. A third leg 1013 of the current path starts at this end of first intermediate battery module 1003 and moves through first intermediate battery module 1003 and ends at the other end of first intermediate battery module 1003. A fourth leg 1014 of the current path moves through second connector 1009, which is connected to the other end of first intermediate battery module 1003 and one end of second intermediate battery module 1004. A fifth leg 1015 of the current path moves through second intermediate battery module 1004. A sixth leg 1016 of the current path moves through third connector 1010, which is connected to the other end of second intermediate battery module 1004 and one end of top battery module 1005. A seventh leg 1017 of the current path moves through top battery module 1005. The current exits the battery via the positive terminal 1007, which is connected to the other end of top battery module 1005. In FIG. 10, the arrows indicate the general direction of the current. As shown earlier, the direction of the current in each battery modules does not necessarily point from one end of the arrow to the other end. Instead, in various embodiments, in each battery module the current may move between different layers of the cell assemblies. Further each battery module may combine more than one cell assemblies connected in parallel, each of which carry the current independent of other cell assemblies.

In some embodiments, the above-discussed design is used in solid-state batteries, lead acid batteries, fuel-cell batteries, or some other types of electrochemical batteries. Other embodiments of the disclosure will be apparent to those skilled in the art from consideration of the specification and practice of the invention disclosed herein. For example, various elements or components of the disclosed embodiments may be combined with other elements or components of other embodiments, as appropriate for the desired application. Thus, it is intended that the specification and examples be considered as exemplary only, with a true scope and spirit of the disclosure being indicated by the following claims.

1. A battery comprising:
a plurality of battery modules connected in series, wherein:
each battery module comprises one or more cell assemblies electrically connected in parallel,
each cell assembly comprises a plurality of electrochemical cells connected in series, and
each electrochemical cell comprises a cathode and an anode ionically connected via a separator;
a container in which the battery modules are sealed from outside the battery; and
a positive terminal and a negative terminal for connecting the outside to the electrically connected battery modules.

2. The battery of claim 1, wherein the plurality of modules are disposed within a common cavity in fluid communication via a common fluid.

3. The battery of claim 2, wherein a common fluid comprises a gas.

4. The battery of claim 1, wherein each battery module has an electric potential of approximately 12 V.

5. The battery of claim 4, wherein the battery comprises four battery modules and provides a minimum electric potential of approximately 48V.

6. The battery of claim 1, wherein each cell assembly comprises a plurality of electrochemical cells connected in series via wire grids.

7. The battery of claim 1, wherein the battery modules are stacked on top of one another.

8. The battery of claim 7, wherein one pair of the battery modules is connected via a power bus.

9. The battery of claim 8, wherein the power bus is attached to the pair of batteries by ultrasonic welding.

10. The battery of claim 8, wherein the power bus has a serpentine configuration.

11. The battery of claim 1, further comprising an isolator plate placed between two adjacent battery modules.

12. The battery of claim 11, wherein the isolator plate comprises rib supports on both sides.

13. The battery of claim 11, wherein the isolator plate comprises a chemical reservoir.

14. The battery of claim 1 comprising an approximately 10-20 Ahr battery.

15. The battery of claim 1 comprising an approximately 15 Ahr battery.
